(19) United States
(12) Patent Application Publication
(10) Pub. No.: US 2026/0020129 A1
(43) Pub. Date: Jan. 15, 2026

(54) LIGHTING CONTROL SYSTEM

(71) Applicant: Inventronics GmbH, Garching b. München (DE)

(72) Inventor: Arnulf Rupp, Oberhaching (DE)

(21) Appl. No.: 19/116,523

(22) PCT Filed: Sep. 26, 2023
(86) PCT No.: PCT/EP2023/076607

§ 371 Date: Mar. 28, 2025

(30) Foreign Application Priority Data
Sep. 30, 2022 (DE) 10 2022 210 455.2

(51) Int. Cl. H05B 47/18; H05B 47/175; H05B 47/19

(52) U.S. Cl. CPC H05B 47/183; H05B 47/19; H05B 47/1965

(57) ABSTRACT

A lighting control system (1) comprises at least one input device (2) configured to provide user-derived, status and/or environmental information to the lighting-control system responsive to a query command (10a) and/or at least one control gear (3) configured to provide power to one or more light sources and to provide status information to the lighting-control system responsive to a query command (10a). Further, it comprises an application controller (4) configured to receive the user-derived and/or environmental information or the status information, and configured to issue a query command (10a) in order to obtain the information or depending on the information obtained. There is further provided a reverse bridge (5), which is configured to communicate with the application controller (2) via a wired network bus (6) operated using a synchronous network protocol, which may conform with IEC 62386-101. The reverse bridge (5) is further configured to communicate with the at least one input device (2) and/or the control gear (3) via a network (7) operated using an asynchronous network protocol, which may conform with IEC 62386-104. The reverse bridge (5) is configured to enable bidirectional communication between the application controller (4) and the at least one input device (2) and/or the control gear (3).

### TECHNICAL FIELD

Various aspects and embodiments relate to a lighting control system including a network, to which input devices and control gear controlled by an application controller are connected. Such aspects and embodiment particularly relate to lighting control system including a wired network bus and extended by an asynchronously operated network part via a bridge, which connects the control and input devices involved in the asynchronously operated network part to the wired network bus where the application controller is arranged. In that configuration, the bridge is called a reverse bridge.

### TECHNICAL BACKGROUND

In building automation, digital bus systems are increasingly used, for example, to centrally or de-centrally control a large number of lighting systems comprising luminaires and sensors. A corresponding standard is provided, for example, by a protocol denoted as DALI (DALI: “Digital Addressable Lighting Interface”). This protocol is defined in the IEC family of standards IEC 62386, among others. It is based on the earlier DSI standard (Digital Signal Interface) and closes the gap between conventional analog 1-10 V interfaces and complex digital bus systems such as KNX/EIB (European Installation Bus) or LON (Local Operating Network), etc., which also include the networking and control of other household appliances beyond lighting.

With the IEC 62386 (“DALI”) communication standard (according to the current status, further developments and extensions are continued to be discussed), each up to a maximum of 64 lighting control gears and input devices may be connected to the bus via corresponding interfaces, which are controlled or monitored by one or more application controllers. Such application controllers serve as masters in the DALI network and are configured as decision taking means. A larger number of control or input devices being involved may be effected by setting up DALI gateways connecting adjacent control networks. The control gear may be electronic ballasts and in particular LED drivers, dimmers or actuators. The input devices may be sensors, switches or other operating means, etc. The respective interfaces may include a controller and a memory in which parameters such as up to 16 programmed scene values or up to 16 group addresses (under which numbers of control and input devices are grouped) are stored. Each interface is addressed individually. The bus has a 2-wire line via which all control and input devices basically receive the same signal in bidirectional data exchange, whereby only the control gear (e.g., LED-drivers) or input device addressed in the signal frame is configured to receive and process the signal, unless the light control system operates in so-called broadcast mode.

The DALI communication standard provides for the bus to be supplied with approximately 16 volts DC. The bus is both a signal line and—albeit to a lesser extent—a power supply. Signals are generated by a transmitting interface by pulsed short circuits between the two wires. The respective sequence of voltage drops from 16 volts to 0 volts is detected and evaluated by the other interfaces connected to the DALI bus. The standard allows certain tolerance ranges of voltage values to be observed for both the transmitting and the receiving device. The information transmitted is cast in transactions, which may each comprise one or more command frames.

In accordance with the present DALI-standard, signals can be transmitted at a rate of 1,200 bits per second, which translates into 833.3 us for one bit. A tolerance range of +10% is generally accepted. Commands or queries issued and transmitted from an application controller or another control device are forward frames having a payload length of 16, 24 or 32 bits. The receiving device (e.g. control gear of input device) is considered to issue and transmit a reply responsive to the command or query in the form of a backward frame having payload length of 8 bits. A leading start bit and a predetermined number of trailing stop bits are added in each case. A reply is to be issued and transmitted in a time bound manner after lapse of the last stop bit of the forward frame: the start bit of backward frame has to be triggered within a time span ranging from 5.5 ms to 10.5 ms after that lapse. Any new forward frame may be initiated only after lapse of 10.5 ms.

The above definitions render the wired DALI bus as a network operated in half duplex mode with synchronous data transfer. However, this pertains to DALI networks as described in IEC 62386 part 101 (system), IEC 62386 part 102 (control gear) and IEC 62386 part 103 (input devices) only.

In the present description, a network operated by using a synchronous network protocol is defined in general by a communication between devices wherein a reply by one device to a notification (command) issued by another device is expected to occur in a time bound manner, and not further device listening to the Communication is expected to issue another notification within such reserved time span on the same medium (wired bus). IEC 62386 part 101 complies with such definition. In contrast, a network operated using an asynchronous network protocol is defined to solve the problem of associating a reply send responsive to a notification (command) with such notification by other means (e.g., attaching further addresses, tags etc. to the packet sent). IP based protocols may generally be asynchronous.

More recently, DALI+ networks have been introduced in IEC 62386 part 104 (General requirements-Wireless and alternative wired system components). Here, DALI+ devices (application controllers, control gear and input devices) communicate with each other using existing DALI transaction, command and reply sets as described above. However, these are carried over a wireless and/or IP-based medium rather than the dedicated pair of wires as used by DALI networks (or DALI-2, which provides for a certification program of the devices involved; or D4i, which is an extension of the DALI-2, wherein LED drivers are provided with a mandatory set of features related to power-supply requirements and smart-data capabilities). Moreover, bridges may be implemented in order to connect devices in conventional wired-bus based DALI networks with the application controller(s) in the wireless and/or IP-based DALI+ network (hereinafter also denoted as “part-104 network”, as opposed to the conventional “part-101 network”). As a nature of a wireless and/or IP-based protocol, part-104 network data transfer is effected in an asynchronous manner.

As noted above, the IEC 62386 part 104 standard provides for the possibility of an application controller arranged in the part-104 network and being allowed to address control gear or input devices in the conventional part-101 network. A so-called reverse bridge, i.e., a bridge that is defined to translate communication originating from an application controller in the part-101 network into the part-104 network, is mentioned, but it is considered therein “being out of scope” of the standard.

Nevertheless, it is been proven feasible to combine conventional DALI bus systems with wireless communication via application gateways that translate between DALI and the respective wireless network protocol of choice. However, no standard is available, yet. Consequently, a difficulty of implementing devices from different vendors arises.

Additionally, existing implementations, in which a part-101 based application controller is connected with DALI devices in a part-104 based network, regularly make use of a simulation of DALI devices in a respective DALI gateway. More specifically, the control devices such as control gear (e.g., LED drivers) are only simulated by the gateway to respond to queries (or commands) within the limited time frame noted above given by the DALI part 101 specification—by using their current simulated state information. The state information itself is continuously updated in the DALI gateway asynchronously via the asynchronously operating network device as a data source. However, no direct feedback reply is provided from the respective part 104-based control device to the part-101 based application controller.

An example of a DALI gateway having similar properties is the CBU-DCS Bluetooth controllable DALI controller, by Casambi Technologies Oy, Espoo, Finland (datasheet CBU-DCS Bluetooth controllable DALI controller, September 2021, downloaded from https://f.hubspotusercontent40.net/hubfs/7177595/Data % 20sheets/English/CBU_DCS_Data-Sheet_EU_EN_2_0_24092021.pdf on Sep. 28, 2022). The CBU-DCS can be connected to wired DALI controllers and acts as a wireless DALI gateway into a Casambi mesh, either in DALI broadcast mode or for controlling individual addressed DALI devices.

Document DE 10 2018 202 965 A1 discloses a lighting control system, wherein a central unit communicates with control devices (control gear) via a DALI bus. Each of the control devices has a DALI interface (“DALI controller”) as well as a Bluetooth interface.

A handheld device communicates via Bluetooth with each of the control devices to access a memory of the control devices. A cloud-based central unit communicates with the control devices either via the handheld device (Bluetooth) or via the DALI bus.

In view of the structure explained above, a reverse bridge which operates based on simulation of status information rather than translating and passing through the information in time needs to have accurate knowledge of the device to be simulated. As noted problems arise when the real device is from a different vendor, and further, when continuous update process of the simulated device involves discrepancies not in synchronization with the real device. In particular, case handling of sudden errors occurring at the device side has to be treated carefully.

### SUMMARY OF THE INVENTION

It is therefore an object to provide a lighting control system composed of a wired-bus network operating with synchronous data transfer and of a asynchronously operated network operating with asynchronous data transfer, both networks communicating using a reversed bridge wherein an application controller is provided on the synchronous bus network side, which lighting control system avoid such out-of-sync situations and where the reversed bridge does not need to continuously collect and store status information of the devices on the asynchronously operated network side.

It is another object to increase the flexibility of such combined networks by allowing to integrate devices from different vendors independent from the type of reversed bridge. Still another object is to allow integration of IP-based DALI+ networks with existing conventional DALI part-101 networks.

Various aspects and embodiments take as a starting point a lighting control system, which comprises at least one input device configured to provide user-derived, status and/or environmental information to the lighting-control system responsive to a query command or event message and/or a control gear configured to provide power to one or more light sources and to provide status information to the lighting-control system responsive to a query command. Typically, both types of devices are present in a lighting control system. The lighting control system further has an application controller configured to receive the user-derived and/or environmental information or the status information, and configured to issue a query command or receive event messages in order to obtain the information or depending on the information obtained.

Additionally, a reverse bridge is provided, which is configured to communicate with the application controller via a wired network bus operate using a synchronous network protocol, and which is configured to communicate with the at least one input device and/or the control gear via a network operated using an asynchronous network protocol. The lighting control system thus provided is compatible with an extended and combined IEC 62386 (DALI) part-101 and IEC 62386 (DALI) part-104 network interconnected via the reverse bridge, which translates or transports between asynchronous network protocol and a synchronous network protocol. However, the aspects and embodiments need not be necessarily restricted to DALI applications and the lighting control system proposed herein may also be compliant with other standards or proprietary protocols.

In the aforementioned lighting control system, the reverse bridge is configured for full bidirectional communication between the application controller and the at least one input device and/or the control gear. This means that commands or queries (“query commands” expecting a reply) issued by application controller on the wired-bus network side are passed through the reverse bridge and forwarded to the input device or control gear, where a reply is prepared and transmitted back to the reverse bridge.

The reverse bridge does not need to collect and store status information just in order to obtain an updated status list of each device on the asynchronously operated network side. The reverse bridge may simply receive and process the information received with the reply to forward it to the application controller via the wired bus network. Various alternatives may be implemented as further embodiments in order to accomplish the necessary translation into the time-bound reply scheme of the synchronously operated wired bus network, or in case of DALI, the part-101 based network.

As a consequence of the full bidirectional communication, the reverse bridge is relieved from providing simulation measures, and thus, any possible inconsistencies between the status information delivered by the reverse bridge to the application controller and the actual status information of the real input or control device can effectively be avoided. Hence, stability and reliability of the lighting control system is enhanced.

Also, due to the relief of the reverse bridge from simulation tasks, the application controller may be structured more simple. No control and handling of a complicated database structure is necessary, and no polling tasks by the bridge to obtain new or current status information needs to be implemented anymore. Hence, the requirements regarding internal control of the reverse bridge are relaxed and memory can be saved. Also, the asynchronously operated network (DALI+) devices, do not need repeated handling of providing status information that might extend beyond the needs of network protocol used, such as DALI.

Still further, as the reverse bridge becomes transparent from the application controller's view when simply passing through the information from the input and control devices (control gear), the requirements to such input and control devices also become more relaxed so that based on a unified standard such as DALI, devices different vendors may be implemented in the combined network.

According to one particularly advantageous alternative aspect, the reverse bridge is configured to transport a forward transaction frame associated with the query command received from the application controller to the input device and/or control gear. The reverse bridge is further configured to issue, to the application controller, a command associated with a corresponding reply frame received from the input device and/or control gear responsive to the forward transaction frame. Here, the purpose of such command is to efficiently deliver reply values for a query when the reply from the asynchronously operated network side (part-104 network side in case of DALI) is actually available.

Consequently, if for example a DALI network is concerned, the bridge may conform with the standard protocol by initiating its own command—instead of a reply to the application controller's first command—in order to transmit the information needed by the application controller. In one embodiment, the reverse bridge is configured to issue the command formed as a forward frame and includes the reply as part of a payload of the command. Hereby, either a new command frame type can be used, for example a frame having different bit lengths as compared with presently defined commands or forward frames, or an existing (DALI−) command (e.g., having 24 bits) can be reused to deliver the reply information.

According to an alternative advantageous aspect, the reverse bridge may be configured to transport a forward transaction frame associated with the query command received from the application controller to the input device and/or control gear similar to the above aspect. However, different from the above aspect, the reverse bridge is further arranged to transport, to the application controller, a reply associated with a corresponding reply frame received from the input device and/or control gear responsive to the forward transaction frame. Here, an advantage arises in that the reply from the input device or control gear transforms again into a reply. Hence, in a further embodiment, in case of DALI, the transaction type may remain the same.

Hereby, according to an embodiment, in order to comply with the limited time span of the synchronously operated wired network bus, the reverse bridge may await a further subsequent command issued to by the application controller such as to enable providing the reply in the predetermined (e.g., DALI−) time span (synchronous data transfer on the wired network bus). The application controller may optionally be suitably arranged to effect polling of the reverse bridge until the desired reply is sent. The repeated command(s) sent from the application controller to the reverse bridge may include counters and/or flags referring to the original first command allowing the reverse bridge to identify the correct command to reply to. Accordingly, according to this embodiment the application controller may be configured to issue a second command subsequent to the first command issued previously, and the reverse bridge maybe configured to transport the reply in response to the second command issued by the application controller.

Furthermore, according to this aspect, as indicated above, the reply transported by the reverse bridge maybe substantially identical to the backward reply frame received by the reverse bridge from the input device and/or the control gear.

In a further embodiment related to this aspect, the reverse bridge may include a memory arranged as a memory page in which the reply is temporarily stored when being received from the input device and/or the control gear. The reverse bridge may thereby be further configured to read out the reply from the memory page, when it receives the second command from the application controller via the wired network bus. The reverse bridge may then transmit the previously received and stored reply frame as the reply to the application controller. Different from the memory management described above with regard to prior art, wherein the status information is kept in the DALI gateway database memory for all devices on the part-104 side, here the plain reply is temporarily stored until the second command is issued. The stored information is then no longer needed. The reverse bridge thus remains passive and need not be concerned with updating information.

According to still another aspect of the lighting control system, the reverse bridge similarly includes a memory as in the previous aspect wherein it is configured to store commissioning information of a new input device and/or a new control gear to be introduced to the lighting control system in the memory. The application controller is further configured to initiate a commissioning process with the new input device and/or control gear via the reverse bridge. This aspect advantageously allows using the reverse bridge to effect the commissioning process. The commissioning process is thus simplified, because it is the reverse bridge which may easily synchronize the information with the new devices in its network.

The application controller maybe configured to issue at least one command via the synchronous wired network bus, which command contains the commissioning information of the new input device and/or new control gear. Hereby, the application controller maybe configured to obtain the commissioning information from a user interface such as commissioning app, which is preferably executed on a mobile device, via wireless data transfer. Furthermore, the reverse bridge maybe configured to receive the command and to store the commissioning information. This alternative is particularly preferred as the application controller is anyway dedicated to keep control of the overall configuration and the reverse bridge is relieved from further configurations tasks and the need to have an own user interface to receive commissioning information. Here, the reverse bridge is operated in a transparent but passive configuration, keeping functions and storing data only to the extent needed.

According to another aspect of the invention, a lighting control system is proposed which comprises, similar to the above aspect, at least one control gear configured to provide power to one or more light sources and to provide status information to the lighting-control system responsive to a query command. Also, the lighting control system comprises an application controller configured to receive the the status information, and further configured to issue a query command in order to obtain the information or depending on the information obtained. Also, similar to the above aspects and embodiments, the lighting control system comprises a reverse bridge which is configured to communicate with the application controller via a wired network bus operated using a synchronous network protocol, and which is configured to communicate with the at least one control gear via a network operated using an asynchronous network protocol. As noted before, such structure is compatible with an extended and combined DALI part-101 and DALI part-104 network interconnected via the reverse bridge.

The lighting control system thus provided further comprises, in addition to the one control gear communicating from the asynchronously operated network side (e.g., DALI part-104 network side), another control gear communicating from the wired network bus side (e.g., DALI part-101 side). The reverse bridge transports commands from the wired network bus to the one control gear.

To accomplish this, hereby, the reverse bridge may be configured to:
(a) copy settings of the other control gear, which is arranged to communicate from the wired network bus side, to the one control gear, which is arranged to communicate from the asynchronously operated network side, at install time.

According to this aspect, the reverse bridge effects that a control gear provided on the asynchronously operated network side simply “follows” a concrete “real” control gear on the wired network bus side as opposed to a simulated control gear typically found in state of the art. The concrete control gear on the wired network bus side may thereby not be affected and may not “recognize” that another device is imitating or copying its performance. On the other hand, as commands transmitted in the direction of the one control gear provided on the synchronously operated network side may not be affected by time limits unlike the replies, these may be easily passed through by the reverse bridge for execution.

In an embodiment, the reverse bridge may further be configured to:
(b) receive and selectively pass-through a command issued by the application controller to an address of the other control gear, which is arranged to communicate from the synchronously operated network side;
(c) forward the received and passed-through command to an address of the one control gear, which is arranged to communicate from the asynchronously operated network side.

In order to address further communication occurring in the network, the reverse bridge may be still further configured to:
(d) filter-out a command issued by the application controller to an address of a third control gear which is arranged to communicate from the synchronously operated network bus side, and to prevent the command from being passed-through to the one control gear, which is arranged to communicate from the asynchronously operated network side; and/or
(e) filter-out any query issued by the application controller to an address of a control gear or control device which is arranged to communicate from the wired network bus side, and to prevent the command from being passed-through to the one control gear, which is arranged to communicate from the asynchronously operated network side.

The proposed “follow-mode” has an advantage in that realization is quite simply and hardly affects the configuration of the wired network bus side. This particularly pertains to DALI implementations of combined wired/wireless networks.

Further aspects and embodiments of the invention relate to the concrete structure of the networks as used in the previous aspects. For example, in the lighting control system of the previous aspects the asynchronously operated network operated using an asynchronous network protocol is a wireless network, wherein a network protocol at the transport layer preferably is Thread, Zigbee, Wifi or Bluetooth/BLE. It is noted that the DALI part-104 specification provides for a number of transport alternatives, which may be both wireless and wired, to the conventional wired DALI bus system. One of the underlying communication protocols in the DALI-part 104 specification is the user datagram protocol (UDP), which is related to Internet Protocol (IP). UDP enables wired (e.g. Ethernet) or wireless (e.g. Thread, WiFi) options. The new specification supports DALI with Thread, which is a wireless, IP-based protocol. Nevertheless, other protocols like those mentioned above may be supported in future, so that the aspects of the invention detailed above shall in no way be limited to DALI-part 104 based networks based on Thread, only.

Nevertheless, it is considered that above aspects become particularly advantageous, when the input device and/or the control gear on one side, and the application controller on the other side are configured to communicate with each other via the reverse bridge using a DALI protocol (IEC 62386), the wired network bus being a DALI-bus and each of the input device and/or the control gear, the application controller and the reverse bridge being provided with a corresponding DALI network interface (the reverse bridge optionally provided with two or more interfaces-minimum one on each side).

Furthermore, the application controller and the reverse bridge maybe configured to communicate with each other using part 101 of the DALI protocol (IEC 62386-101), and/or the input device and/or the control gear and the reverse bridge communicate with each other using part 104 of the DALI protocol (IEC 62386-104).

Further advantages, features and details of the various aspects are apparent from the claims, from the following description of preferred embodiments and from the drawings. In the figures, the same reference signs denote the same features and functions.

### BRIEF DESCRIPTION OF THE DRAWINGS

Therein:

FIG. 1 shows in a schematical illustration a lighting control system according to a first embodiment;

FIG. 2 shows in a schematical illustration a lighting control system according to a second embodiment;

FIG. 3 shows in a schematical illustration a lighting control system according to a third embodiment;

FIG. 4 shows in a schematical illustration a lighting control system according to a fourth embodiment.

### DETAILED DESCRIPTION OF PREFERRED EMBODIMENTS

In the following description of preferred embodiments, it should be appreciated that the present disclosure of the various aspects is not limited to the details of the construction and arrangement of the components as shown in the following description and figures. The embodiments may be put into practice or carried out in various ways. It should also be noted that the expressions and terminology used herein are for purposes of specific description only and should not be construed by the skilled person as such in a limiting manner. Furthermore, in the following description, the same reference signs in the various embodiments or figures designate the same or similar features or objects, so that in some cases a repeated detailed description of the same is omitted in order to preserve the compactness and clarity of the presentation.

In the following, four embodiments will be explained in more detail, wherein each of the four embodiments is based on a combined DALI part-101 and part-104 network. As noted the principles developed with regard to these embodiments may also apply other standards or even proprietary arrangements, and may also apply to advanced DALI systems developed in the future but based on the present definitions. It is noted that the name of DALI may change in such further developments or standard versions (such as “D4i”) whereas the embodiments detailed below may still be compatible with such advanced DALI standard.

Additionally, the part-104 based network shown in the figures is supported by Thread as an underlying IP protocol. However, it is appreciated that other underlying protocols may embodied in a similar way, even if it is not wireless, such as Thread, but wired, such as Ethernet. The standard DALI+ (including a part-104 based network) as employed in the embodiments and figures, among others, includes a system address which multiplies the number of possible devices by 255, and where an IP-based carrier is used such as Thread, this extension goes further, providing an almost unlimited addressing capability. Accordingly, the number of devices on the part-104 network side shown in the embodiments may likewise be increased to an arbitrary number as needed. The number of devices on the part-101 network side may be limited to 64 each for input devices and control gear, respectively, according to the standard.

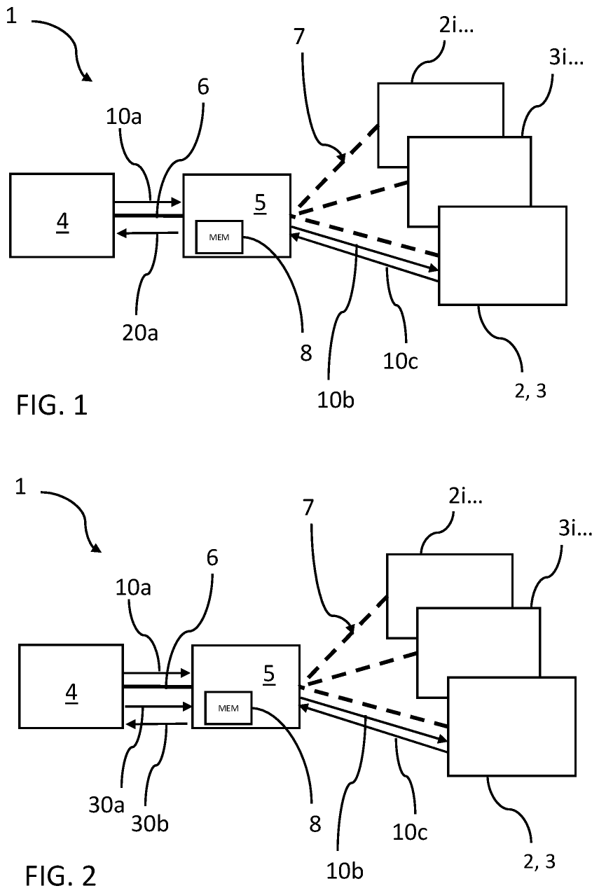

The two first embodiments shown in FIGS. 1 and 2 illustrate a DALI lighting control system comprising an application controller 4 connected (via a DALI interface) with a 2-wire (classical) DALI part-101 based wired network bus 6, a reverse bridge 5 device having a 2-wire DALI interface and a part-104 based (herein wireless) interface. Further, a plurality of control gears 3, 3i, . . . and input devices 2, 2i, . . . are each provided comprising a 104-based (herein wireless) interface. It is noted that the mentioned DALI interfaces—be it part-101 based or part-104 based—are not shown in the figures for the sake of clarity. Numeral 7 denotes a DALI part-104 based wireless asynchronously operated network.

The first embodiment is illustrated in FIG. 1 and may be most preferred. The application controller 4 and the reverse bridge may be adapted and configured to exchange specific commands which allow a full bidirectional communication between the application controller 4 and the control gears 3, 3i and input devices 2, 2i without simulation of status information etc. Firstly, a communication process starts with the application controller 4 sending a query command 10a to the reverse bridge 5. The query command may be part of a transaction containing one or multiple commands instructing a control gear to adapt lighting conditions (e.g., change power supply) or simply querying in order to obtain status information or change settings. In both cases, the application controller 4 may expect a confirmation or information to be sent in one or more frames via a reply back to the application controller.

The reverse bridge 5 is configured to receive the query command 10a via DALI part-101 based wired network bus 6 at its respective DALI part-101 interface and transports it to the DALI part-104 based wireless asynchronously operated network 7 via its respective other interface. The query command is thereby forwarded as an encapsulated part-104 based forward transaction frame 10b over the wireless network and is received by control gear 3 or input device 2, depending on the short address contained in the forward transaction frame.

The control gear 3 or input device 2 (whatever is applicable here) replies with a reply frame 10c to the reverse bridge 5, including the confirmation or other information requested. The reverse bridge then issues a command 20a to finally deliver the reply value requested by the original query command 10a to the application controller 4 as part of the payload of the command 20a (e.g. DALI data transfer register 2 (DTR2)). As noted above, in the communication, frames may be formed of one or more commands (e.g. a combination of setting a DTR0 register and an instruction using DTR0) and one or more frames may form a transaction which, when transmitted over the wired bus, requires a dedicated time bound scheme for transmission of its constituent parts.

Such command 20a according to this embodiment may be realized in various alternatives. The purpose of command 20a is to efficiently deliver reply values of the previous query command 10a from the application controller 4, just upon when the reply from the 104-side is available at the reverse bridge 5. Thereby, the query command 10a may be a single query or a transaction containing multiple commands and queries as specified according to DALI standard part-101. In the non-limiting specific embodiment detailed below, up to 7 queries per one transaction may be addressed by the command prepared by the reverse bridge 5.

According to one specific option, a new command frame type may be specified and taken advantage of. The new command frame type may include, for example, 20-bit frames. The frame bits may be arranged as follows: SSSS XXXXXXXX YYYYYYYY.

Using such a bit arrangement, up to 4 frames may be needed to supply all reply values (information or confirmation). In the above bit arrangement, S denotes a sequence number incremented for every transaction 10a, X denotes a bit mask with reply flags (inside the first frame) or subsequent reply values 2, 4, 6, and Y denotes reply values 1, 3, 5, 7.

According to another specific option, a DALI command of the already existing command set may be re-used to deliver the reply values. Here, the 24-bit special commands DTR1: DTR0 or DTR2: DTR1 are preferred, because two bytes payload are possible with a single 24-bit command. The arrangement of bits in the frame then is AAAAAAAA XXXXXXXX YYYYYYYY, again with up to 4 frames being needed to supply all reply values. In the above bit arrangement, A denotes address-Byte 0xC7 or 0xC9 for commands DTR1: DTR0 and DTR2: DTR1, respectively, X denotes a bit mask with reply flags (inside the first frame) or subsequent reply value 2, 4, 6, and Y denotes reply values 1, 3, 5, 7.

In the preferred implementation of the forward command 20a as shown in FIG. 1, the bit mask with flags is prepared as follows. As noted, up to 4 frames (be it 20 or 24 bit frames as described above) are needed to provide the up to 7 reply values. The 4 frames may be sent in one transaction on the part-101 bus 6 by the reverse bridge 5 to the application controller 4 to avoid interruption. In general, the application controller 4 may only expect such frames from the reverse bridge. Here, no other application controllers sending forward frames is expected to be part of the system.

In order to optimize the number of commands needed, it is useful to only provide a value for those query commands 10a inside the overall transaction of related command queries 10a which resulted in a reply value on the part-104 asynchronously operated network 7 side. The bit mask (e.g., the X-bits in the first frame) may indicate efficiently which of the query commands actually resulted in a reply. For example, in the first frame frame, the bit mask is set as: XXXXXXXX→CFFFFFFF, wherein C indicates, if any of the queries led to multiple replies on the part-104 side, and F denotes the bit mask with one bit for each of the up to 7 queries in the overall transaction, indicating if a reply was received (for example=1), or no reply was received (for example=0) from the part-104 side. E.g., starting with the lowest significant bit standing for the first command query within the overall transaction, wherein non-query commands in the overall transaction are discarded from the bit representation.

Hereby, only those reply values for the query commands having a “1” in the bit-mask may subsequently be added as Y-bits and following X-bits, thereby effectively avoiding transmission unused bits for queries with no reply. Further, the C-bit is set in the above bit mask if multiple devices responded to minimum one of the queries. In that case the query resulting in multiple replies may provide the value 0xFF indicating MASK.

Some examples are given below:
(a) Transaction with 1 query command, which created a response:
Query: 0x0190→QUERY STATUS sent to control gear (3) short address 0
Response: DTR2: DTR1 (0x01, 0x04)→results in one valid reply with value 0x04 (→0xC90104).
(b) Transaction with 2 query commands and upon receiving the commands, one response is created:
Query: 0x0391 0x0103 0x0190→QUERY CONTROL GEAR PRESENT (addr: 1), STEP UP (addr: 0), QUERY STATUS (addr: 0)
Response: DTR2: DTR1 (0x02, 0x0B)→one valid reply with value 0x0B (i.e., third command frame corresponds to second query command).
(c) Transaction with 7 query commands, all responded:
Query: 0x01C5, 0x01C5, 0x01C5, . . . →7 times READ MEMORY LOCATION (DTR1, DTR0)
Response: DTR2: DTR1 (0x7F, 0x01), DTR2: DTR1 (0x02, 0x03), DTR2: DTR1 (0x04, 0x05), DTR2: DTR1 (0x06, 0x07)→results in 7 reply values (1,2,3,4,5,6,7)

A second embodiment is shown in FIG. 2. As described above with reference to FIG. 1, a transaction starts with the application controller 4 sending a query command 10a to the reverse bridge 5. The query command may be a command instructing a control gear to adapt lighting conditions (e.g., change power supply) or a simple query in order to obtain status information or change settings.

The reverse bridge 5 is configured to receive the query command 10a via DALI part-101 based wired network bus 6 at its respective DALI part-101 interface and transports it to the DALI part-104 based wireless asynchronously operated network 7 via its respective other interface. The query command is thereby forwarded as an encapsulated part-104 based forward transaction frame 10b over the wireless network and is received by control gear 3 or input device 2, depending on the short address contained in the forward query frame.

The control gear 3 or input device 2 (whatever is applicable here) replies with a reply frame 10c to the reverse bridge 5, including the confirmation or other information requested. The reverse bridge 5 then stores the information in a memory 8 (MEM) and awaits a further query command 30a from the application controller. If that query command is issued, the reverse bridge 5 reads out the information (reply value) from the memory 8 and includes it in a frame of the reply 30b and sends it to the application controller 4.

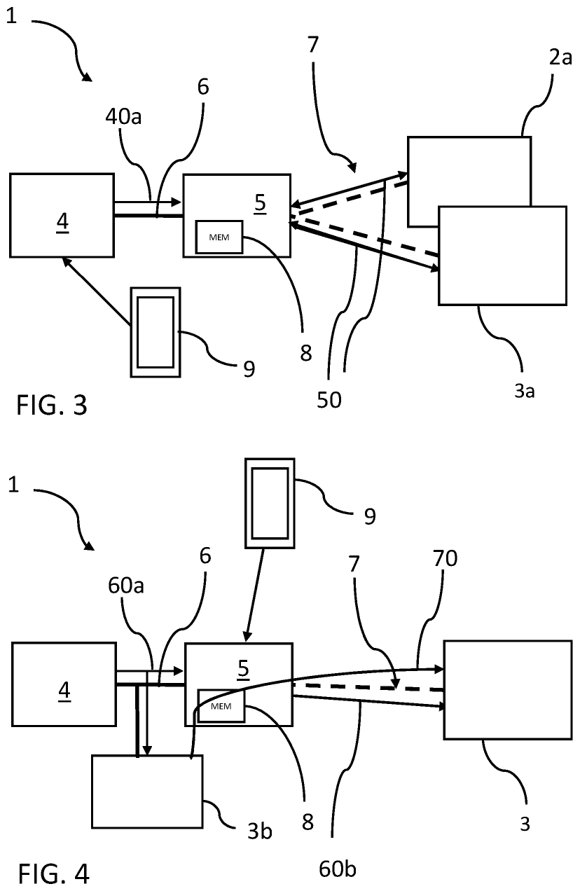

A third embodiment is shown in FIG. 3. Here the application controller 4 transmits a multitude of commands 40a to set values in the memory 8 (into respective memory pages; MEM) including commissioning information such as the EUI64 (64-Bit Extended Unique Identifier, denotes a MAC-address format for identification of network devices standardizes by IEEE) and a commissioning secret PSKd of the Thread-based part-104 device (control gear 3 or input device 2). After completing the data transfer to the memory 8, the reverse bridge 5 initiates the commissioning process with a device newly joining the network using the information then read out from memory 8.

A preferred implementation of a memory page in memory 8 is as follows. The memory page contains information about the devices (control gear 2, input devices 2) present on the part-104 asynchronously operated network 7 side, about replies available for polling and joining secrets for devices that shall join the network (wherein the reverse bridge 5 acts as Thread commissioner). An example of a memory page is shown in table 1.

TABLE 1

| | | Default | RESET | Memory |
|---|---|---|---|---|
| Address | Description | Value | Value | Type |
| 0x00 | Address of last | | No change | ROM |
| | accessible memory | | | |
| | location | | | |
| 0x01 | Indicator byte | any | Any | any |
| 0x02 | Lock byte | 0xFF | 0xFF | RAM |
| 0x03 | Short address of the | 0xFF | No change | NVM |
| | application controller to | | | |
| | be informed about | | | |
| | changes | | | |
| 0x04 | Flags: CFFFFFFF | 0x00 | 0x00 | RAM |
| 0x05 . . . | Reply values for all | 0x00 | 0x00 | RAM |
| 0x0B | queries for F = 1 in the | | | |
| | flags byte (address 0x04) | | | |
| 0x0B . . . | EUI-64 for Thread Joiner | 0x00 | 0x00 | RAM |
| 0x13 | Device | | | |
| 0x14 . . . | PSKd for Thread Joiner | 0x00 | 0x00 | RAM |
| 0x23 | Device | | | |
| 0x24 . . . | Bit mask (64-bit) | 0x00 | 0x00 | RAM |
| 0x2B | indicating with | | | |
| | control gear short | | | |
| | addresses have been | | | |
| | discovered on the | | | |
| | 104-side | | | |
| 0x2C . . . | Bit mask (64-bit) | 0x00 | 0x00 | RAM |
| 0x34 | indicating with control | | | |
| | device short addresses | | | |
| | have been discovered on | | | |
| | the 104-side | | | |
| 0x35 | Operation / Status byte | 0x00 | 0x00 | RAM |
| | (xxxxAEJD) | | | |

In more detail, the memory 8 holds the reply values available for polling (as an alternative to commands 20a sending the replies in the first embodiment). Further, the short address of the application controller 2 indicates if an application controller 2 expects to receive indications for reply values. 0xFF (MASK) deactivates notifications. Alternative command formats may use short addressing to send information to the application controller 2.

Moreover, EUI-64 and PSKd are joiner secrets specific to the Thread protocol (as an example for a part-104 network technology). Once the last byte of PSKd is written, the reverse bridge 5 starts to act as a Thread commissioner and adds the device (input device 2 or control gear 3) with given a EUI-64 (which as noted above corresponds to a MAC address) to the list of devices, which is expected to add to the network. Any success or failure can be observed by reading the status byte (address 0x36). The process starts when the J-bit is set in the Operation/Status Byte and terminates when the J-bit is clear (on read). The E-bit may indicate that an error has occurred.

The Bit-masks at address 0x24 . . . 0x2B and address 0x2C . . . 0x34 indicate, which short address is used on the part-104 side asynchronously operated network 7 of the reverse bridge 5. Identification of already used short addresses starts when the D-bit is set in the Operation/Status Byte and terminates when the D-bit is clear (on read). The reverse bridge 5 is configured to automatically assign short addresses to the device (control gear 3 and/or input device 2) on the 104-side (e.g. using address search known from conventional DALI) when the A-bit is set in the Operation/Status Byte.

A fourth embodiment is shown in FIG. 4. Here, instead of simulating a DALI device present in the part-104 asynchronously operated network 7, a real DALI-2 device (“another” control gear 3b) on the part-101 wired network bus 6 side is implemented and the reverse bridge 5 is configured to make one or multiple devices in the part-104 asynchronously operated network to “follow” this device. More specifically, the reverse bridge 5 is configured to:
copy settings (70) of the other control gear 3b, which is arranged to communicate from the wired network bus 6 side, to the one control gear 3, which is arranged to communicate from the asynchronously operated network 7 side, at install time.

Further, the reverse bridge 5 maybe configured to:
receive and selectively pass-through a command (60a) issued by the application controller 2 to an address of the other control gear 3b, which is arranged to communicate from the wired network bus 6 side; and
forward the received and passed-through command (60b) to an address of the one control gear 3, which is arranged on the asynchronously operated network 7 side.

Moreover, in order deal with other commands and/or queries, the reverse bridge 5 is further configured to:
filter-out a command issued by the application controller 2 to an address of a third control gear which is arranged to communicate from the wired network bus 6 side, and to prevent the command from being passed-through to the one control gear 3, which is arranged on the asynchronously operated network 7 side; and/or
filter-out any query issued by the application controller 2 to an address of a control gear or control device which is arranged to communicate from the wired network bus 6 side, and to prevent the command from being passed-through to the one control gear 3, which is arranged to communicate on the asynchronously operated network 7 side.

### LIST OF REFERENCE NUMERALS

1 lighting control system
2 input device (e.g., sensor, switch)
2a new input device (to be commissioned)
3 control gear (e.g. LED driver)
3a new control gear (to be commissioned)
3b “other” control gear: connected within wired bus network
4 application controller
5 reverse bridge
6 synchronously operated network (wired network bus)
7 asynchronously operated network (e.g., wireless network (Thread) or ethernet)
8 memory
9 user interface (commissioning app)
10a query command
10b forward transaction frame
10c reply frame
20a command
30a second command
30b reply provided in response to query command 30a
40a commissioning setting command
50 messages between bridge and the one control gear or control device in the asynchronous network
60a command (no query)
60b forward frame following command

1. A lighting control system, comprising:
at least one input device configured to provide information including at least one of a group consisting of user-derived information, status information, environmental information, and combinations thereof to the lighting control system responsive to a first query command;
an application controller configured to receive the information, and configured to issue the first query command in order to obtain the information, issue a second query command depending on the information obtained, or issue both the first query command and the second query command; and
a reverse bridge, which is configured to communicate with the application controller via a wired network bus operated using a synchronous network protocol, and which is configured to communicate with the at least one input device via a network operated using an asynchronous network protocol;
wherein the reverse bridge is configured for bidirectional communication between (i) the application controller and (ii) the at least one input device.

2. The lighting control system according to claim 1, wherein
the reverse bridge is configured to transport at least one forward transaction frame associated with the first query command, the second query command, or both the first query command and the second query command received from the application controller to the at least one input device, and to issue, to the application controller, a command associated with a corresponding reply frame received from the at least one input device responsive to the at least one forward transaction frame.

3. The lighting control system according to claim 2, wherein
the reverse bridge is configured to issue the command formed as a forward frame and including a reply as part of a payload of the command.

4. The lighting control system according to claim 2, wherein
the reverse bridge is configured to transport a forward query frame associated with the first query command, the second query command, or both the first query command and the second query command received from the application controller to the at least one input device, and to transport, to the application controller, a reply associated with a corresponding reply frame received from the at least one input device responsive to the at least one forward transaction frame.

5. The lighting control system according to claim 4, wherein
the application controller is configured to issue a second command subsequent to the first query command, the second query command, or both the first query command and the second query command issued previously; and
the reverse bridge is configured to transport the reply in response to the second command issued by the application controller.

6. The lighting control system according to claim 5, wherein
the reverse bridge includes a memory in which a reply value from the reply frame is temporarily stored when received from the at least one input device; and
the reverse bridge is configured to read out the reply from the memory when it receives the second command, and to transmit the reply value from the reply frame as the reply to the application controller.

7. The lighting control system according to claim 1, wherein
the reverse bridge includes a memory and is configured to store commissioning information of a new input device to be introduced to the lighting control system in the memory; and
the reverse bridge is configured to initiate a commissioning process with the new input device.

8. The lighting control system according to claim 7, wherein
the application controller is configured to issue at least one command via the wired network bus using the synchronous network protocol, wherein the at least one command contains the commissioning information of the new input device; and
the reverse bridge is configured to receive the at least one command and to store the commissioning information in the memory.

9. A lighting control system, comprising:
at least one control gear configured to provide power to one or more light sources and to provide status information to the lighting control system responsive to a query command;
an application controller configured to receive the status information, and configured to issue the query command and another query command;
a reverse bridge, which is configured to communicate with the application controller via a wired network bus operated using a synchronous network protocol, and which is configured to communicate with the at least one control gear via a network operated using an asynchronous network protocol;
the lighting control system further comprising, in addition to the at least one control gear communicating with the reverse bridge on a side of the network operated using an asynchronous network protocol, another control gear communicating from a side of the wired network bus operated using a synchronous network protocol;
wherein the reverse bridge is configured to:
copy settings of the another control gear, which is arranged to communicate from the wired network bus side, to the at least one control gear, which is arranged to communicate on the asynchronously operated network side, at install time.

10. The lighting control system according to claim 9, wherein
the reverse bridge is further configured to:
receive and selectively pass-through a command issued by the application controller to an address of the another control gear, which is arranged to communicate from the wired network bus side;
forward the received and passed-through command to an address of the at least one control gear, which is arranged to communicate on the asynchronously operated network side.

11. The lighting control system according to claim 10, wherein
the network operated using an asynchronous network protocol is a wireless network.

12. The lighting control system according to claim 10, wherein
the at least one control gear on one side, and the application controller on the other side are configured to communicate with each other via the reverse bridge using a Digital Addressable Lighting Interface (DALI) protocol (IEC 62386), the wired network bus operated using a synchronous protocol being a DALI-bus and each of the at least one control gear, the application controller and the reverse bridge being provided with a corresponding DALI network interface.

13. The lighting control system according to claim 12, wherein
the application controller and the reverse bridge are configured to communicate with each other using part 101 of the DALI protocol (IEC 62386-101); and
the at least one control gear and the reverse bridge communicate with each other using part 104 of the DALI protocol (IEC 62386-104).

14. The lighting control system according to claim 8, wherein
the application controller is configured to obtain the commissioning information directly from a user interface.

15. The lighting control system according to claim 14, wherein
the user interface is executed on a mobile device via wireless data transfer.

16. The lighting control system according to claim 10,
wherein the reverse bridge is further configured to:
filter-out a command issued by the application controller to an address of a third control gear which is arranged to communicate from the wired network bus side, and to prevent the filtered-out command from being passed-through to the at least one control gear, which is arranged on the asynchronously operated network side.

17. The lighting control system according to claim 10,
wherein the reverse bridge is further configured to:
filter-out any query issued by the application controller to an address of a third control gear, a control device, or both the third control gear and the control device, wherein the third control gear, the control device, or both the third control gear and the control device is arranged to communicate from the wired network bus side, and
prevent the command from being passed-through to the at least one control gear, which is arranged on the asynchronously operated network side.

18. The lighting control system according to claim 11, wherein
a network protocol of the wireless network at a transport layer is Thread, Zigbee, Wifi or Bluetooth/Bluetooth low energy (BLE).

19. A lighting control system, comprising:
at least one control gear configured to provide power to one or more light sources and to provide status information to the lighting control system responsive to a first query command;
an application controller configured to receive the status information, and configured to issue the first query command in order to obtain the status information, issue a second query command depending on the status information obtained, or issue both the first query command and the second query command; and
a reverse bridge, which is configured to communicate with the application controller via a wired network bus operated using a synchronous network protocol, and which is configured to communicate with the at least one control gear via a network operated using an asynchronous network protocol;
wherein the reverse bridge is configured for bidirectional communication between (i) the application controller and (ii) the at least one control gear.

20. The lighting control system of claim 19, further comprising:
at least one input device configured to provide information including at least one of a group consisting of user-derived information, status information, environmental information, and combinations thereof to the lighting control system responsive to a third query command;
wherein the reverse bridge is configured to communicate with the at least one input device via a network operated using an asynchronous network protocol; and
wherein the reverse bridge is configured for bidirectional communication between (i) the application controller and (iii) the at least one input device.
